(19) United States
(12) Patent Application Publication
(10) Pub. No.: US 2018/0257969 A1
(43) Pub. Date: Sep. 13, 2018

(54) GLASS FORMING MACHINE LEVELING SHIMS AND METHOD OF USING SAME

(71) Applicant: PYROTEK, INC., Spokane, WA (US)

(72) Inventors: John Daniel Bridgewater, Jenks, OK (US); Ronald Anthony Napier, Coweta, OK (US)

(21) Appl. No.: 15/916,555

(22) Filed: Mar. 9, 2018

Related U.S. Application Data
(60) Provisional application No. 62/469,004, filed on Mar. 9, 2017.

(51) Int. Cl. C03B 9/40; C03B 9/353; C03B 9/447

(52) U.S. Cl. CPC C03B 9/40; C03B 9/447; C03B 9/3532

(57) ABSTRACT

A method and tool for adjusting components of a machine that produces glass bottles. A shim is positioned between two components. The shim includes a base element and an adjustable element. The base element has a component engaging surface and a stepped surface. At least several of the steps project a greater distance than other steps. The adjustable element has a component engaging surface and a stepped surface. At least several of the steps of the adjustable element project a greater distance than other steps. The stepped surface of the adjustable element rests on the stepped surface of the base element such that rotation or sliding of the adjustable element allows the steps of the adjustable element and the steps of the base element to mate in a manner wherein the component engaging surfaces are moved closer to or further from one another.

This application claims the priority of U.S. Provisional Application No. 62/469,004, filed Mar. 9, 2017, the disclosure of which is herein incorporated by reference.

### BACKGROUND

The present exemplary embodiment relates to leveling shims suitable for use in glass bottle forming apparatus typically referred to as individual section (I.S.) glass forming machines. It finds particular application in conjunction with adjustment of the pins, hangers and inserts when mounting, setting up and properly aligning molds and other components of an I.S. machine, and will be described with particular reference thereto. However, it is to be appreciated that the present exemplary embodiment is also amenable to other like applications.

An I.S. machine has a number of identical sections each of which produces a bottle from a gob of molten glass in a two step process. The first step is to form the molten gob into a parison in a blank station and the second step, performed on the parison after it has been pivoted 180° from the blank station to the blow station, is to blow the parison into a bottle. The bottle is removed from the blow station by a takeout and placed on a dead plate which is a horizontal plate having a number of holes through which cool air is blown upwardly to cool the formed bottle. When the bottle has cooled sufficiently to be stable, it is transferred from the deadplate to a conveyor which carries the bottle away from the machine. Exemplary glass bottle molding apparatus are described in U.S. Pat. Nos. 1,843,159; 1,911,119; 4,379,581; and 8,286,448, the disclosures of which are herein incorporated by reference.

The surfaces of the I.S. machine components are subject to wear and as a result the relative position of components that work together can shift over time. Mold halves are an example of I.S. machine components that require close tolerance or imperfections can be formed in the surface of formed bottles. Historically, when mold components become out of alignment, the mold halves are removed from the mold hanger arm and shims inserted. When further adjustment is required, the process is repeated. FIG. 1 is a schematic illustration of a mold half detached from the hanger arm. The traditional dog bone (6) and round (7) shims used to adjust the position of the mold half and the oval shims (8) used to adjust the height of the wind chamber when re-attached to the hanger arm are also illustrated.

Another example of machine components that require adjustment over time is the orientation of the conveyor and dead plate. Dead plate assemblies have been designed where the deadplate is mounted on a supporting frame and the deadplate and supporting frame are interconnected firmly with four screws. To vertically reposition the deadplate to maintain the deadplate surface aligned with the surface of the conveyor, these four screw have to be unscrewed, the deadplate must be removed from the windbox, shim plates must be located between the windbox and the deadplate, and the four screws must be remounted.

Unfortunately the time required to disassemble the I.S. machine components to insert new shims results in significant downtime for the machine.

### BRIEF DESCRIPTION

According to a first embodiment, a method for adjusting components of a machine that produces glass bottles is provided. The method comprises positioning a shim between two components. The shim includes a base element and an adjustable element. The base element has a component engaging surface and a stepped surface having a plurality of steps. At least several of the steps project a greater distance than other steps. The adjustable element has a component engaging surface and a stepped surface having a plurality of steps. At least several of the steps of the adjustable element project a greater distance than other steps. The stepped surface of the adjustable element rests on the stepped surface of the base element such that rotation or sliding of the adjustable element allows the steps of the adjustable element and the steps of the base element to mate in a manner wherein the component engaging surfaces are moved closer to or further from one another.

According to a second embodiment, a tool for adjusting the relative height of at least two components of a machine is provided. The tool comprises a shim including a base element and an adjustable element. Each element includes a passage configured to overlap the passage in the corresponding element and receive a post or bolt. The base element has a component engaging surface and a stepped surface having a plurality of steps. The adjustable element has a component engaging surface and a stepped surface having a plurality of steps. At least several of the steps of one or both of the base element and the adjustable element project a greater distance. The stepped surface of the adjustable element rests on the stepped surface of the base element in an assembled condition such that rotation or sliding of the adjustable element allows the steps of the adjustable element and the steps of the base element to mate in a manner wherein the component engaging surfaces are moved closer to or further from one another.

According to a further embodiment, a tool for adjusting the relative height of at least two components of a machine is provided. The tool comprises a shim including a base element and an adjustable element. Each element includes a passage configured to overlap the passage in the corresponding element and receive a post or bolt. The base element has a component engaging surface and a working surface including steps or ridges. The adjustable element has a component engaging surface and a working surface having a plurality of steps or ridges. At least one of the base element and the adjustable element has steps. At least several of the steps of one or both of the base element and the adjustable element project a greater distance from other steps on the same working surface. The working surface of the adjustable element rests on the working surface of the base element in an assembled condition such that rotation or sliding of the adjustable element allows the steps and the opposed steps or ridges to mate in a manner wherein the component engaging surfaces are moved closer to or further from one another.

### BRIEF DESCRIPTION OF THE DRAWINGS

FIG. 1 is a schematic illustration of a the prior art methodology for adjusting the height of a I.S. machine wind chamber relative to the hanger arm;

FIG. 2 is a schematic illustration of an adjustable shim mechanism of the present disclosure;

FIG. 3 is a top plan view of FIG. 2 with the hanger arm removed;

FIGS. 4 and 4A are illustrations of an adjustable dog bone base;

FIGS. 5 and 5A are illustrations of an adjustable shim;

FIGS. 6A and 6B are illustrations of an oval base;

FIGS. 7A and 7B are illustrations of an adjustable oval shim; and

FIG. 8 is an illustration of an associated tool.

### DETAILED DESCRIPTION

The present disclosure is directed to a new glass forming machine part. The part is used in conjunction with pins, hangers and inserts, etc., when mounting, setting up and properly aligning equipment used to form glass containers, such as on an I.S. machine.

In one embodiment, two multi-sided (for example 6) steel shims with incremental adjusting steps machined into a surface of the part are provided. These shims can be used in conjunction with a dog bone shaped bottom part. In a further embodiment, a rectangular shaped part with incremental machined steps can be used in conjunction with an oval bottom part. A wrench designed to fit two of the flat sides or a mating projection of the adjusting shims can be included. The wrench is used to rotate or slide and adjust the shims, which fit on top of the base parts. As the leveling shims are rotated or slid using the wrench, the height or relative spacing of the glass forming machine part is raised or lowered allowing for leveling and improved alignment as required to produce defect free glass containers. The subject adjustable leveling shims can take the place of steel washers and allow for small incremental adjustments of 0.002″ at a time, for example, resulting in much quicker and easier set up of glass container forming machines.

The time to mount and properly set up new container glass forming molds onto a mold hanger arm can be reduced by several hours, resulting in less downtime for the machine and increased output for the manufacturer.

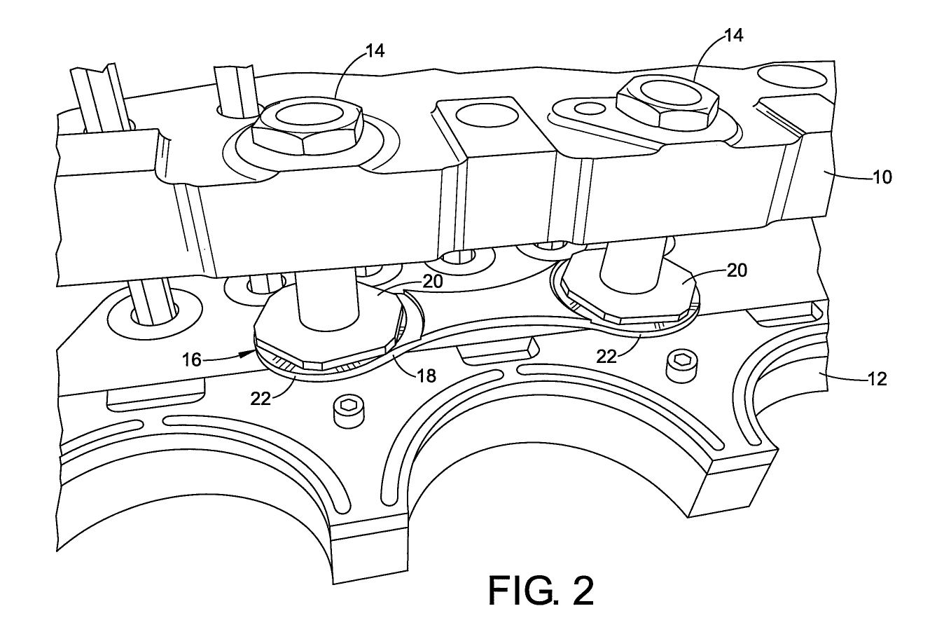

Illustrated in FIGS. 2 through 5A is a two-piece adjustable shim adapted to control the spacing between two components of a glass forming machine. This shim system is also adaptable to other uses, for example, in instances where trueness of perpendicular or other angular relationships are desired.

Demonstrated in FIG. 2 is the adjustable shim configuration of the present disclosure. The blank hanger arm 10 is attached to a first mold half 12 through a pair of bolts 14. Interposed between the blank hanger arm 10 and the first mold half 12 is the adjustable shim arrangement 16 of the present disclosure. In the illustration of FIG. 2 the blank hanger arm 10 is shown as suspended above the first mold half 12, but in a fully assembled condition, the hanger arm blank 10 would engage the first mold half 12 with the adjustable shim arrangement 16 providing spacing there between.

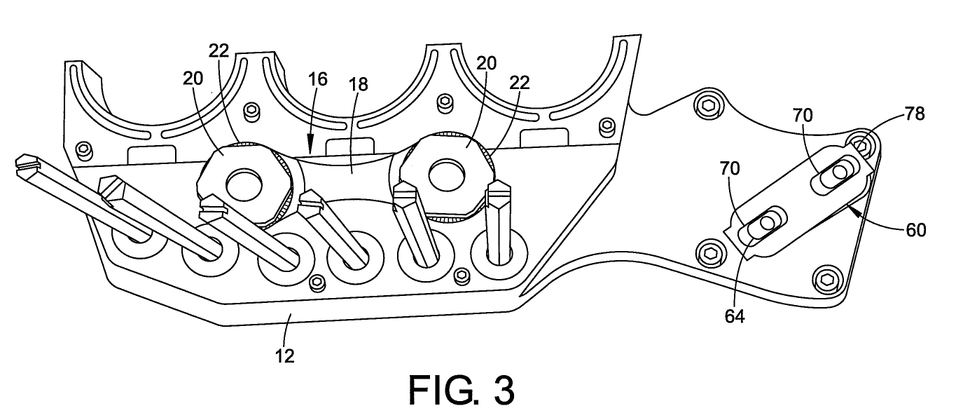

With further reference to FIGS. 3-5A, it can be seen that the adjustable shim arrangement 16 includes a dog bone base element 18 and a pair of adjustable elements 20. The adjustable elements 20 rest upon the generally circular end segments 22 of the base element 18. While the base element is not required to conform to a dog bone shape, it is selected for this disclosure as it corresponds to what is traditional in the art.

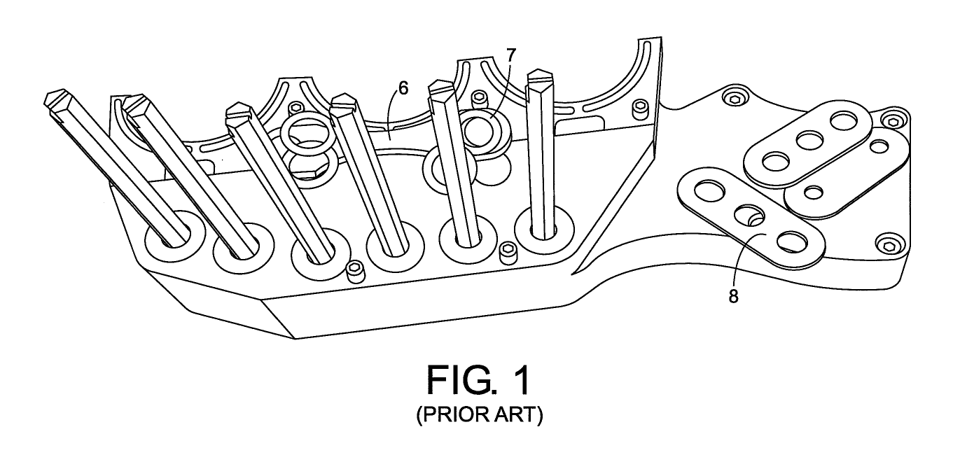

Base element 18 includes passages 24 in each of circular end segments 22 and each adjustable element 20 includes a passage 26. Passages 24 and 26 are oriented to align such that bolts 14 can pass from hanger arm blank 10, through the base element 18 and adjustable elements 20, for attachment to first mold half 12 (see FIG. 2). In this manner, when hanger arm blank 10 is secured to first mold half 12, the adjustable shim arrangement 16 is positioned therebetween, allowing for adjustable spacing to be selectively tailored by the machine assembler. It is also noted that adjustment of spacing after assembly can be performed simply by loosening the bolts 28 and rotating adjustable elements 20 (as discussed in detail below). This is contrasted by the requirement for complete disassembly of the hanger arm blank from the first mold half when employing the traditional shim elements shown in FIG. 1.

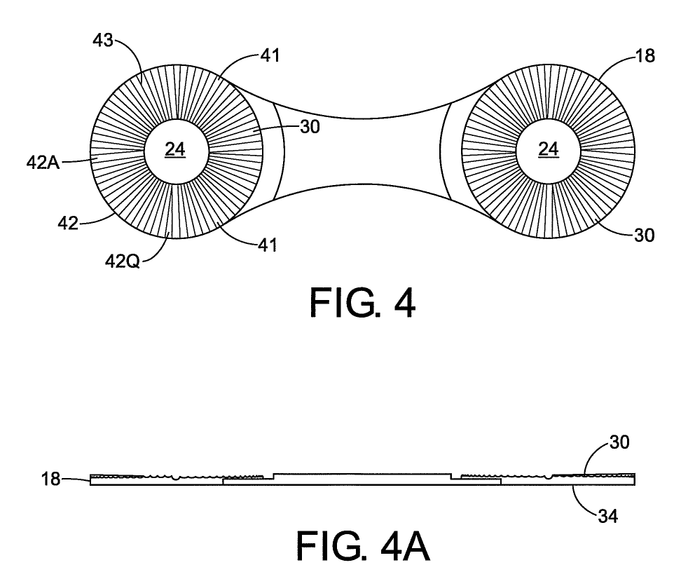

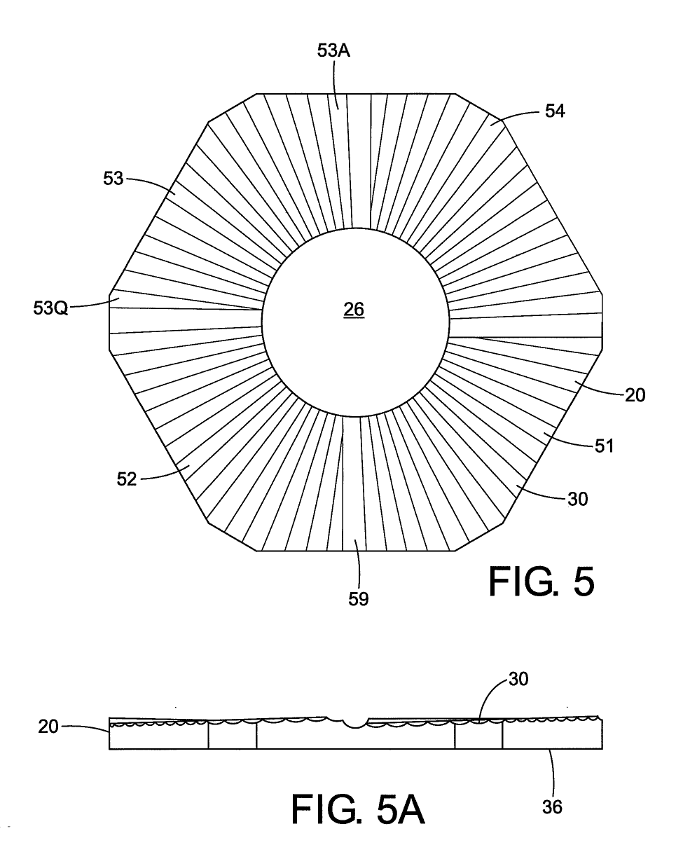

With particular reference to FIGS. 4, 4A, 5 and 5A, the relationship between the adjustable elements 20 and the circular end segments 22 of the base element 18 is illustrated. Moreover, the interfacing surface of each element includes a plurality of steps 30 oriented in a general wheel-spoke configuration which radiate outwardly from the respective passages 24/26. In can be advantageous that the configuration of steps in the base element 18 and the associated adjustable element 20 be at least substantially the same. However, it is not required that the same number of steps be employed on each surface. Similarly, it is not required that each end of the base element 18 be of the same configuration.

In certain applications the steps can increase in height between adjacent steps a distance of about 0.0005″ to about 0.01″, or about 0.001″ to about 0.005″. The size of the steps is not critical, but an exemplary change in distance between the component engaging surface 34 of the base element 18 and the component engaging surface 36 of the adjustable element 20 achieved by rotation from one step position to the next can be between about 0.0001″ and 0.02″. It is contemplated that the suitable size of steps is one that allows meaningful adjustability yet is sufficiently small to allow practical rotation of the adjustable element to be performed. Moreover, steps too large cannot be easily rotated while steps too small provide insufficient adjustment.

In certain applications the stepped surfaces of the adjustable and base elements can be formed into sections. These sections can include steps that originate at a low height and progressively increase in height. It is envisioned that at least two sections will be included within the configuration of steps on each element. It is further envisioned that at least three sections will be provided such that at least three points of engagement are provided between the base element and the adjustable element at any location of rotation there between. It is also envisioned that four sections may be beneficial as this provides four points of contact creating a stable interface and provides 90° of rotational freedom to maximize the range of height adjustment available. It is contemplated that the sections can be equal in length.

It is further envisioned that the number of steps within each section on each of the adjustable element and the base element can be at least substantially the same to facilitate precise mating between the two elements. In this manner, by aligning the lowest step of the adjustable element with the highest step of the base member (and vice versa) the adjustable shim arrangement provide its smallest mold half-hanger arm dimension. Rotation of the adjustable element 20 relative to the stationary base element 18 results in sliding of adjacent steps over one another such that the steps of the adjustable element engage the next highest step of the base member.

Turning now to FIGS. 4, 4A, 5, and 5A, the sectioned formation of the steps is illustrated. Particularly, the stepped surface 40 of the base element 18 and the stepped surface 50 of the adjustable element 20 include four sections 41, 42, 43, 44 and 51, 52, 53, 54, respectively. Generally, it is envisioned that each section will increase from a lowest step to a highest step and that the lowest step of one section will be adjacent the highest step of the preceding section. It is contemplated that the sections will be separated by partition walls 59. After rotation past the partition wall, the adjustable element 20 will drop again to a low point. Since each of the sections can be substantially the same, the following discussion will focus on sections 42 and 52.

As illustrated each of sections 42 and 53, which overlap in an assembled condition, are comprised of steps which progressively increase in height from lower most step 42A and 53A to highest steps 42Q and 53Q.

FIG. 8 depicts a tool 57 suitable for engaging the edges of adjustable element 20 to permit rotation and the associated modification of shim height. Of course, the tool can be of any configuration that allows the shims to be properly gripped for adjustment. This will be largely dependent upon the shape of the shims themselves.

It is further noted, that the disclosure contemplates steps formed in each of the adjustable element and the base element. However, it is feasible to form the stepped surface in either element and provide the corresponding element with only ridges upon which the associated steps can be rotated upon. For example, in keeping with the preceding paragraph, four ridges could be formed on the base element upon which steps of varying height formed on the adjustable element would rest. Rotation of the adjustable element such that steps of greater or lesser height rest on the ridges would result in increase or decrease of the distance between the component engaging surfaces or the adjustable element and the base element. In most applications, it may be beneficial to provide at least three ridges (points of engagement) such that a stable interface is formed between the adjustable element and the base element.

Turning now to another embodiment of the disclosure, reference is made to FIGS. 3, 6A and 6B, wherein a rectangular sliding adjustable shim arrangement 60 is illustrated. Shim arrangement 60 can be associated with mounting of a wind chamber (not shown). The elongated adjustable shim arrangement 60 is comprised of two elements, namely, an oval base member 62 and a generally rectangular slide member 64. The base member 62 can be a substantially flat piece of metal or other at least substantially rigid material having an upper surface 66 and a lower surface 68. Lower surface 68 functions as the component engaging surface and upper surface 66 includes steps or ridges which receive slide member 64. Slide member 64 similarly includes a ridged or stepped surface oriented to interlace with the upper surface 66 of the base member 62. Each of base member 62 and slide member 64 include passages for receiving a machine screw or bolt. The base member 62 includes circular passages 67. The slide member 64 can include elongated passages 70 which allow the slide member 64 to be moved along its longitudinal axis to facilitate adjustment of height.

Each (or only one) of the mating faces of the base member 62 and the slide member 64 can include steps 72 oriented perpendicular to the longitudinal axis of the shim arrangement 60. Similarly to the embodiment(s) described above, the stepped surface can include sections. For example, the slide member 64 can include four sections 74, wherein the steps increase in height in each section from a first lowest step 76A to a final highest step 76P (only one section is illustrated with step reference characters). By releasing pressure on the shim arrangement 60, tool 57 (or another object) can engage either end of the slide member 64 at either of the squared engagement edges 78 and push the slide member 64 into one of a lower or higher configuration.

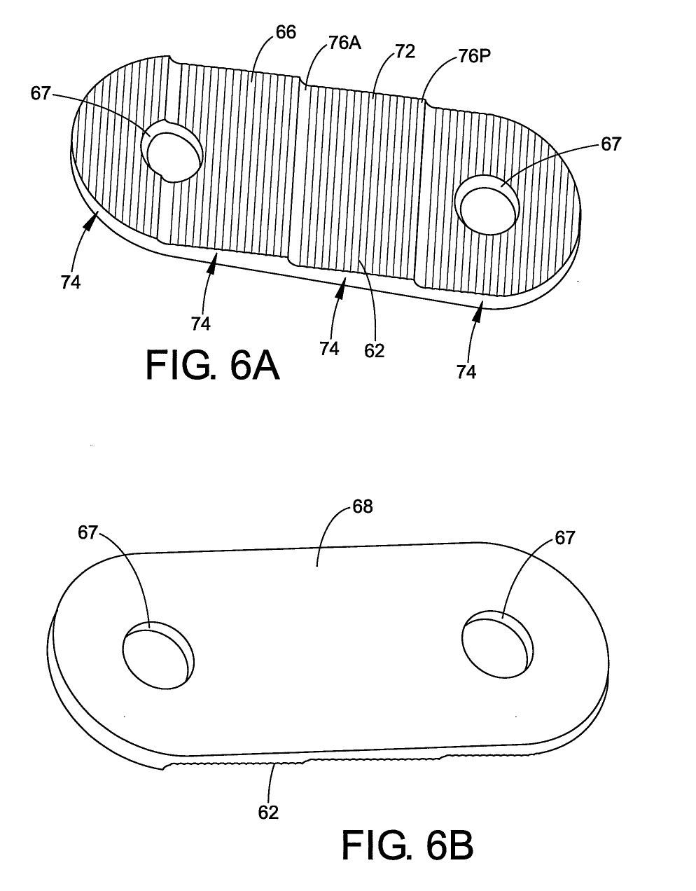

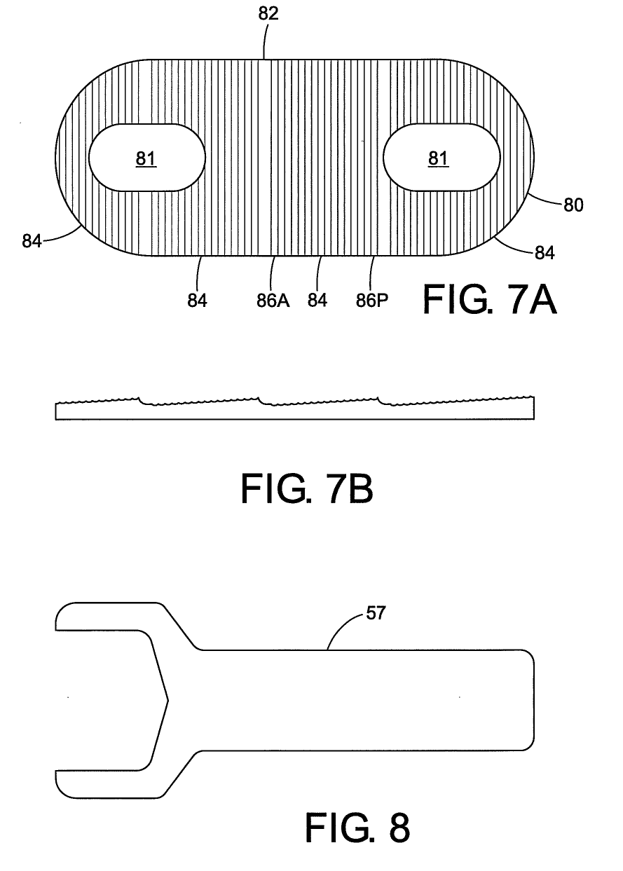

With reference to FIGS. 7A and 7B, an alternative slide member 80 is depicted. Slide member 80 is substantially the same as rectangular slide member 64 but with an oval shape. Slide member 80 similarly includes elongated passages 81 and steps 82 formed into step zones 84 which increase in height from step 86A to step 86P.

In certain embodiments, the base element and the adjustable element of either shim arrangement 16 or 60 may include an indicia or other marking suitable for aligning the steps and/or ridges in one of a greatest height, a lowest height, or an intermediate height orientation.

Advantageously, instead of using a number of small thickness shims to build up the desired shim zone spacing after disassembly, the present disclosure provides a pair of cooperating shim members that can be adjusted simply by loosening machine anchor bolts and then adjusting the position of the shim by rotating or sliding one of the shim elements to provide the correct spacing for the relevant zone.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A method for adjusting components of a machine that produces glass bottles comprising positioning a shim between two components, said shim including a base element and an adjustable element, said base element having a component engaging surface and a stepped surface having a plurality of steps, at least several of said steps projecting a greater distance, the adjustable element having a component engaging surface and a stepped surface having a plurality of steps, at least several of said steps projecting a greater distance, the stepped surface of said adjustable element resting on the stepped surface of said base element, wherein rotation or sliding of said adjustable element allows the steps of the adjustable element and the steps of the base element to mate in a manner wherein the component engaging surfaces are moved closer to or further from one another.

2. The method of claim 1 wherein said adjustable element is rotated.

3. The method of claim 1 wherein said adjustable element comprises a polygonal circumferential shape.

4. The method of claim 3 wherein said shape includes 4-8 sides.

5. The method of claim 4 wherein said shape comprises a hexagon.

6. The method of claim 1 wherein said base element comprises a dog bone shape.

7. The method of claim 6 wherein each end of the dog bone includes said steps.

8. The method of claim 1 wherein said steps comprise radially extending ridges approaching or intersecting a passage through the element and approaching or intersecting an exterior sidewall.

9. The method of claim 8 wherein said steps are disposed in a spoke and wheel pattern, and wherein said pattern is comprised of at least four zones of steps which increase in height from a low point adjacent a neighboring zone to a high point adjacent a subsequent zone.

10. The method of claim 1 wherein a tool is used to engage and rotate the adjustable element.

11. The method of claim 1 wherein said adjustable element comprises an elongated body having a longitudinal axis and wherein said steps are disposed perpendicular to said axis.

12. The method of claim 11 wherein said elongated body includes at least one passage.

13. The method of claim 12 wherein said steps are comprised of at least two zones on opposed sides of said passage and wherein steps on a first side of said passage are greater in height than steps on the second side of said passage.

14. The method of claim 13 wherein said body includes at least two passages.

15. The method of claim 1 wherein adjacent steps vary in height by less than 0.005″.

16. The method of claim 1 wherein the base element and the adjustable element include an indicia or other marking suitable for aligning the steps in one of a greatest height, lowest height, or intermediate height orientation.

17. A tool for adjusting the relative height of at least two components of a machine, said tool comprising a shim including a base element and an adjustable element, each element including a passage, said passages configured to overlap a passage in the corresponding machine and receive a post or bolt, said base element having a component engaging surface and a stepped surface having a plurality of steps, the adjustable element having a component engaging surface and a stepped surface having a plurality of steps, at least several of said steps of one or both of the base element and the adjustable element projecting a greater distance, the stepped surface of said adjustable element resting on the stepped surface of said base element in an assembled condition, wherein rotation or sliding of said adjustable element allows the steps of the adjustable element and the steps of the base element to mate in a manner wherein the component engaging surfaces are moved closer to or further from one another.

18. The tool of claim 17 wherein said adjustable element is rotatable.

19. The tool of claim 17 wherein said steps are disposed in a spoke and wheel pattern, and wherein said pattern is comprised of at least four zones of steps which increase in height from a low point adjacent a neighboring zone to a high point adjacent a subsequent zone.

20. A tool for adjusting the relative height of at least two components of a machine, said tool comprising a shim including a base element and an adjustable element, each element including a passage, said passages configured to overlap the passage in the corresponding element and receive a post or bolt, said base element having a component engaging surface and a working surface including steps or ridges, the adjustable element having a component engaging surface and a working surface having a plurality of steps or ridges, at least one of the base element and the adjustable element having steps, at least several of said steps of one or both of the base element and the adjustable element projecting a greater distance, the working surface of said adjustable element resting on the working surface of said base element in an assembled condition, wherein rotation or sliding of said adjustable element allows the steps and the opposed steps or ridges to mate in a manner wherein the component engaging surfaces are moved closer to or further from one another.
